(19) United States
(12) Patent Application Publication
(10) Pub. No.: US 2023/0003428 A1
(43) Pub. Date: Jan. 5, 2023

(54) GAS-LIQUID SEPARATOR AND THERMAL MANAGEMENT SYSTEM

(71) Applicant: ZHEJIANG SANHUA INTELLIGENT CONTROLS CO., LTD., Shaoxing City, Zhejiang Province (CN)

(72) Inventors: JUNQI DONG, Shaoxing City, Zhejiang Province (CN); LI LI, Shaoxing City, Zhejiang Province (CN); MEI WANG, Shaoxing City, Zhejiang Province (CN)

(21) Appl. No.: 17/781,354

(22) PCT Filed: Apr. 1, 2021
(86) PCT No.: PCT/CN2021/085091

§ 371 Date: May 31, 2022

(30) Foreign Application Priority Data
Apr. 3, 2020 (CN) 202010261377.8

(51) Int. Cl. F25B 43/00; B01D 19/00

(52) U.S. Cl. CPC F25B 43/006; B01D 19/0042; F25B 2400/23; F25B 2500/28

(57) ABSTRACT

A gas-liquid separator includes a first cylinder body, a second cylinder body, a first flow guide portion, a second flow guide portion, a gas-liquid distribution assembly and a heat exchange assembly. The first cylinder body is located inside the second cylinder body. The gas-liquid separator has a first cavity and a second cavity. The heat exchange assembly is at least partially located in the first cavity. The heat exchange assembly includes a heat exchange tube, a first heat exchange member and a second heat exchange member. The heat exchange tube at least partially surrounds the first cylinder body. The first heat exchange member and the second heat exchange member have different structures. A thermal management system having the gas-liquid separator is also disclosed.

### CROSS-REFERENCE TO RELATED APPLICATION

This application claims priority of a Chinese Patent Application No. 202010261377.8, filed on Apr. 3, 2020 and titled “GAS-LIQUID SEPARATOR AND THERMAL MANAGEMENT SYSTEM”, the entire content of which is incorporated herein by reference.

### TECHNICAL FIELD

The present application relates to a technical field of air conditioners, and in particular, to a gas-liquid separator and a thermal management system.

### BACKGROUND

In an air-conditioning system, an intermediate heat exchanger is used to exchange heat between a high-temperature refrigerant from a condenser and a low-temperature refrigerant from an evaporator to increase the temperature of the refrigerant entering a compressor. In a cooling mode, the temperature of the refrigerant before throttling can also be reduced, thereby improving the cooling efficiency of the evaporator. Most compressors can only compress a gaseous refrigerant. If a liquid refrigerant enters the compressor, it will cause liquid shock and damage the compressor. In order to reduce the liquid shock of the compressor, a gas-liquid separator is installed before the compressor.

In a related art, a gas-liquid separator integrating heat exchange and gas-liquid separation functions is adopted. The gas-liquid separator includes an inner cylinder body, an outer cylinder body and an interlayer cavity between the inner cylinder body and the outer cylinder body. A device with gas-liquid separation function is located inside the inner cylinder body. A device with heat exchange function is located outside the inner cylinder body. The liquid refrigerant after gas-liquid separation is stored in the inner cylinder body. The refrigerant entering the interlayer cavity exchanges heat with the device with heat exchange function. In a cooling mode, the temperature of the refrigerant entering a throttling device is reduced, the cooling effect is improved, and the liquid shock phenomenon of the compressor can be further reduced. Under the condition that diameters of the inner cylinder body and the outer cylinder body remain unchanged, the structural arrangement of the heat exchange member of the heat exchange assembly will affect the distribution of the refrigerant in the interlayer cavity, thereby affecting the heat exchange effect of the device with heat exchange function. In the related art, the heat exchange members on two sides of the heat exchange tube have the same structure, so that the heat exchange capacities on the two sides of the heat exchange tube are the same. However, the requirements for the heat exchange capacity on the two sides of the heat exchange tube are different, and setting the structure of the heat exchange members on the two sides of the heat exchange tube to be the same will result in a waste of the interlayer cavity space.

### SUMMARY

In view of the above problems existing in the related art, the present application provides a gas-liquid separator and a heat management system with different structures of heat exchange members on two sides of a heat exchange tube.

In order to achieve the above object, the present application adopts the following first technical solution:
a gas-liquid separator, including: a first cylinder body, a second cylinder body, a first flow guide portion, a second flow guide portion, a gas-liquid distribution assembly and a heat exchange assembly;
the first cylinder body being located inside the second cylinder body, the gas-liquid separator having a first cavity and a second cavity, the first cavity at least including a space inside the second cylinder body and outside the first cylinder body, the second cavity at least including a space inside the first cylinder body, the heat exchange assembly being at least partially located in the first cavity;
the gas-liquid distribution assembly including a flow guide pipe, the first flow guide portion being fixed with the second cylinder body, the first flow guide portion having a third cavity, the flow guide pipe being fixed with the first flow guide portion, one end of the flow guide pipe communicating with the third cavity, another end of the flow guide pipe communicating with the second cavity, the third cavity communicating with the first cavity;
the second flow guide portion being fixed with the second cylinder body, the first flow guide portion and the second flow guide portion being located on opposite sides of the second cylinder body;
the heat exchange assembly including a heat exchange tube, a first heat exchange member and a second heat exchange member, the heat exchange tube at least partially surrounding the first cylinder body, one side of the first heat exchange member being disposed adjacent to or attached to the second cylinder body, another side of the first heat exchange member being fixed with the heat exchange tube, one side of the second heat exchange member being disposed adjacent to or attached to the first cylinder body, an other side of the second heat exchange member being fixed with the heat exchange tube, a structure of the first heat exchange member being different from a structure of the second heat exchange member.

In order to achieve the above object, the present application adopts the following second technical solution:
a gas-liquid separator, including: a first cylinder body, a second cylinder body, a first flow guide portion, a second flow guide portion, a gas-liquid distribution assembly and a heat exchange assembly;
the second cylinder body being sleeved on an outside of the first cylinder body, the gas-liquid separator having a first cavity and a second cavity, the first cavity at least including a portion located between the second cylinder body and the first cylinder body, the second cavity at least including a portion located in the first cylinder body;
the first flow guide portion and the second flow guide portion being located at opposite ends of the second cylinder body, respectively; the first flow guide portion and the second flow guide portion being fixed to the second cylinder body, respectively; the first air guide having a third cavity communicating with the first cavity;
the gas-liquid distribution assembly including a flow guide pipe communicating with the second cavity and the third cavity;
the heat exchange assembly including a heat exchange tube, a first heat exchange member and a second heat exchange member, the heat exchange tube being at least partially located in the first cavity, the first heat exchange member and the second heat exchange member being located on opposite sides of the heat exchange tube, the first heat exchange member and the second heat exchange member being fixed to the heat exchange tube, respectively; a structure of the first heat exchange member being different from a structure of the second heat exchange member.

In the present application, the structures of the first heat exchange member and the second heat exchange member located on opposite sides of the heat exchange tube are different. Compared with the first heat exchange member and the second heat exchange member in the related art having the same structures and the same heat exchange capacities on two sides of the heat exchange tube, under the condition that the diameters of the first cylinder body and the second cylinder body remain unchanged, the present application makes a difference in the heat exchange capacities on the two sides of the heat exchange tube according to the requirements of the gas-liquid separator for the heat exchange capacity of the heat exchange assembly, so that the heat exchange capacity of the heat exchange assembly is fully utilized.

A thermal management system includes the above gas-liquid separator. The thermal management system further includes an evaporator, a compressor, a condenser and a throttling device. The gas-liquid distribution assembly is connected between the evaporator and the compressor. The heat exchange assembly is connected between the condenser and the throttling device. An outlet of the evaporator is connected to the first flow guide portion of the gas-liquid separator. An inlet of the compressor is connected to the second flow guide portion of the gas-liquid separator. An outlet of the condenser is connected to the second flow guide portion. An inlet of the throttling device is connected to the first flow guide portion.

### BRIEF DESCRIPTION OF DRAWINGS

FIG. 1 is a schematic perspective structural view of a gas-liquid separator in an embodiment of the present application;

FIG. 2 is a perspective exploded schematic view of the gas-liquid separator in the embodiment of the present application;

FIG. 3 is a schematic exploded perspective view of a first flow guide portion of the gas-liquid separator in the embodiment of the present application;

FIG. 4 is a schematic exploded perspective view of a second flow guide portion of the gas-liquid separator in the embodiment of the present application;

FIG. 5 is a perspective exploded schematic view of a heat exchange assembly of the gas-liquid separator in the embodiment of the present application;

FIG. 6 is a schematic cross-sectional view of the gas-liquid separator in the embodiment of the present application;

FIG. 7 is a perspective cross-sectional structural schematic view of the gas-liquid separator in the embodiment of the present application;

FIG. 8 is a schematic cross-sectional view of the gas-liquid separator in the embodiment of the present application;

FIG. 9 is a schematic top view of the heat exchange assembly of the gas-liquid separator in another embodiment of the present application;

FIG. 10 is a schematic top view of the heat exchange assembly of the gas-liquid separator in another embodiment of the present application;

FIG. 11 is a schematic perspective structural view of the first heat exchange member or the second heat exchange member in some embodiments, wherein a is a staggered tooth structure, b is a hollow corrugated structure, c is a hollow strip structure, d is a louver structure, e is a strip structure with perforated sidewalls, and f is a hollow corrugated structure with perforated sidewalls; and

FIG. 12 is a schematic connection view of a thermal management system in an embodiment of the present application, wherein directions indicated by arrows are flow directions of the refrigerant, and the thermal management system is now in a cooling mode.

### DETAILED DESCRIPTION

Exemplary embodiments will be described in detail here, and examples thereof are shown in the drawings. When the following description refers to the drawings, unless otherwise indicated, the same numbers in different drawings indicate the same or similar elements. The implementation embodiments described in the following exemplary embodiments do not represent all implementation embodiments consistent with the present application. On the contrary, they are merely examples of devices and methods consistent with some aspects of the present application as detailed in the appended claims.

The terms used in the present application are only for the purpose of describing specific embodiments, and are not intended to limit the present application. The singular forms of “a”, “said” and “the” described in the present application and appended claims are also intended to include plural forms, unless the context clearly indicates otherwise.

It should be understood that “first”, “second” and similar words used in the specification and claims of the present application do not denote any order, quantity or importance, but are only used to distinguish different components. Similarly, similar words such as “a” or “an” do not mean a quantity limit, but mean that there is at least one. A phrase such as “a plurality of” means two or more than two. Unless otherwise indicated, similar words such as “front”, “rear”, “lower” and/or “upper” are only for convenience of description, and are not limited to one position or one spatial orientation. Terms such as “including” or “comprising” and other similar words mean that the elements or components before “including” or “comprising” now cover the elements or components listed after “including” or “comprising” and their equivalents, and do not exclude other elements or components.

A gas-liquid separator according to the exemplary embodiments of the present application will be described in detail below with reference to the accompanying drawings. Features in the embodiments and implementations described below may complement each other or be combined with each other without conflict.

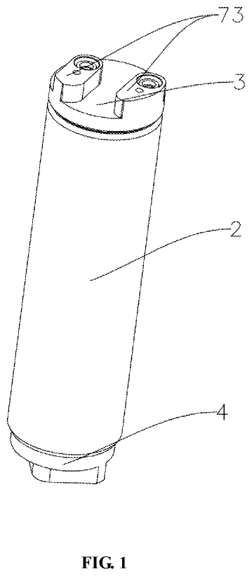

FIG. 1 is a schematic perspective assembly view of a gas-liquid separator 100 according to an exemplary embodiment of the present application. The gas-liquid separator 100 can be applied to various thermal management systems, and can be applied to many fields such as household air conditioners, commercial air conditioners, and automobiles. Alternatively, it can be applied to an electric vehicle air conditioning system.

According to a specific embodiment of the gas-liquid separator 100 of the present application, as shown in FIG. 1 to FIG. 8, the gas-liquid separator 100 includes a first cylinder body/inner cylinder body 1, a second cylinder body/outer cylinder body 2, a first flow guide portion 3, a second flow guide portion 4, a gas-liquid distribution assembly 5 and a heat exchange assembly 6.

In this embodiment, the first cylinder body/inner cylinder body 1 and the second cylinder body/outer cylinder body 2 are both hollow cylinders with a substantially circular cross section. An outer diameter of the first cylinder body 1 is smaller than an inner diameter of the second cylinder body 2. The first cylinder body 1 is located inside the second cylinder body 2. The gas-liquid separator 100 has a first cavity/interlayer cavity 10 and a second cavity/inner cavity 20. The first cavity 10 is located in the second cylinder body 2. The first cavity 10 is located outside the first cylinder body 1. The second cavity 20 includes at least a space inside the first cylinder body 1. The second cavity 20 is formed in the first cylinder body 1. The gas-liquid distribution assembly 5 is at least partially located in the second cavity 20. The first cavity 10 at least includes a cavity surrounded by an outer wall surface of the first cylinder body 1 and an inner wall surface of the second cylinder body 2. The heat exchange assembly 6 is at least partially located in the first cavity 10.

The first flow guide portion 3 and the second flow guide portion 4 are fixed to opposite sides of the second cylinder body 2 in an axial direction, respectively. One end surface of the second cylinder body 2 is surrounded by part of the first flow guide portion 3, and the other end surface is surrounded by part of the second flow guide portion 4. One end surface of the first cylinder body 1 abuts against the first flow guide portion 3, and the other end surface of the second cylinder body 2 abuts against the second flow guide portion 4. In some embodiments, the first flow guide portion 3 may be connected to the first cylinder body 1 and the second cylinder body 2, or may abut against each other through a sealing structure. The second flow guide portion 4 may be connected to the first cylinder body 1 and the second cylinder body 2, or may abut against each other through a sealing structure. The first flow guide 3 has a third cavity/interval cavity 30. The gas-liquid distribution assembly 5 is fixed with the first flow guide portion 3. The gas-liquid distribution assembly 5 communicates with the second cavity 20, the third cavity 30 and an outside of the gas-liquid separator 100. The third cavity 30 communicates with the first cavity 10.

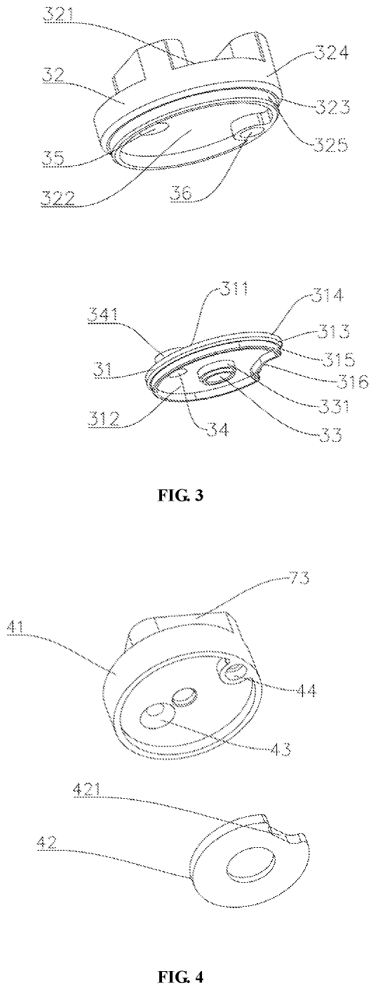

In this embodiment, as shown in FIG. 3, the first flow guide portion 3 includes a first part 31 and a second part 32 which are disposed at intervals. Along the axial direction of the gas-liquid separator 100, a projection of the first part/cover 31 completely falls into a projection of the second part/the first end cap 32. The first part 31 is fixed to the first cylinder body 1. The second part 32 is fixed to the second cylinder body 2. The third cavity 30 includes at least a space between the first part 31 and the second part 32. The first part 31 includes a first through hole 33 communicating with the third cavity 30 and a second through hole 34 communicating with the second cavity 20. The second part 32 includes a third through hole 35 that communicates with the outside of the gas-liquid separator 100.

The gas-liquid distribution assembly 5 includes a flow guide pipe 51 and a connecting pipe 52. One end of the connecting pipe 52 is fixed to the first part 31, and the other end is fixed to the second part 32. The flow guide pipe 51 is fixed to the first part 31. The flow guide pipe 51 is at least partially located in the second cavity 20. The connecting pipe 52 is at least partially located in the third cavity 30. An inner cavity of the flow guide pipe 51 communicates with the first through hole 33. An inner cavity of the connecting pipe 52 communicates with the second through hole 34 and the third through hole 35.

Along the axial direction of the gas-liquid separator 100, the projection of the first cylinder body 1 completely falls into the projection of the first part 31. An outer contour shape of the first part 31 is substantially the same as a cross-sectional shape of the first cylinder body 1.

The first part 31 includes a first end surface 311 away from the first cylinder body 1, a second end face 312 opposite to the first end face 311, and a first stepped surface 313. The first stepped surface 313 divides the side wall surface of the first part 31 into two sections, namely, a first side wall surface 314 and a second side wall surface 315. The first stepped surface 313 is externally connected to the first sidewall surface 314, and is internally connected to the second sidewall surface 315. An upper end surface of the first cylinder body 1 abuts against the first stepped surface 313. In some embodiments, part of the inner wall surface of the first cylinder body 1 is attached to the second side wall surface 315. The first through hole 33 and the second through hole 34 both form openings on the first end surface 311 and the second end surface 312. The upper end surface of the first cylinder body 1 and the first part 31 are fixedly connected by brazing, gluing or electromagnetic pulse welding.

The second part 32 includes a third end surface 321 away from the second cylinder body 2, a fourth end face 322 opposite to the third end face 321, and a second stepped surface 323. The second stepped surface 323 divides the side wall surface of the second part 32 into two sections, namely, a third side wall surface 324 and a fourth side wall surface 325. The second stepped surface 323 is externally connected to the third sidewall surface 324, and is internally connected to the fourth sidewall surface 325. An upper end surface of the second cylinder body 2 abuts against the second stepped surface 323. In some embodiments, part of the inner wall surface of the second cylinder body 2 is fixedly attached to the fourth side wall surface 325 by brazing, gluing or electromagnetic pulse welding. The third through hole 35 has openings formed on both the third end surface 321 and the fourth end surface 322.

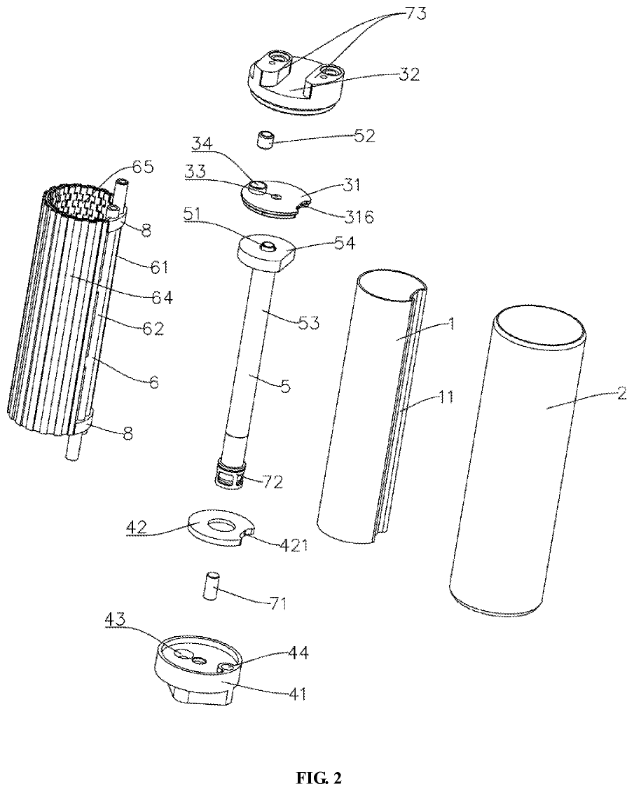

The gas-liquid separator 100 also includes a pipeline connection assembly. The pipeline connection assembly is connected to the second part 32. The pipeline connection assembly includes a first connecting member 73 with a first channel, a second connecting member (not shown) with a second channel, a fastener (not shown) connecting the first connecting member 73 and the second connecting member, and a sealing member (not shown) provided between the first connecting member 73 and the second connecting member. When the first connecting member 73 and the second connecting member are connected by the fastener, the first channel communicates with the second channel, and the sealing element is compressed. The connection between the first channel and the second channel is sealed by the sealing element. One of the first connecting member 73 and the second connecting member is connected to the second part 32, and the other of the first connecting member 73 and the second connecting member is connected to a pipe. The first channel and the second channel communicate with the third through hole 35 and the outside of the gas-liquid separator 100. When the first connecting member 73 and the second connecting member are fixedly connected by the fastener, the second cavity 20 communicates with an external pipe. The gas-liquid separator 100 is connected to the thermal management system. It can be understood that, in the present application, the connection between the pipeline connection assembly and the second part 32 means that one of the first connecting part 73 and the second connecting part can be integrally formed with the second part 32 (refer to FIG. 2); or, the pipeline connection assembly and the second part 32 may be processed and connected together after being formed.

In some embodiments, referring to FIG. 3, an edge portion of the opening of the first through hole 33 located on the second end surface 312 extends toward the second cavity 20 so as to form a first extension portion 331, and an inner sidewall of the first extension portion 331 is connected to part of the outer sidewall of the flow guide pipe 51, thereby increasing the reliability of the connection between the flow guide pipe 51 and the first part 31. An edge portion of the opening of the second through hole 34 located on the first end surface 311 extends toward the third cavity 30 so as to form a second extension portion 341, and an inner sidewall of the second extension portion 341 is connected with part of the outer sidewall of the connecting pipe 52, thereby increasing the reliability of the connection between the connecting pipe 52 and the first part 31.

In the present embodiment, referring to FIG. 4, the second flow guide portion 4 includes a third part/second end cap 41 and a fourth part 42 disposed at intervals. The third part 41 is covered to an end of the second cylinder body 2 away from the first flow guide portion 3, and the fourth part 42 is covered to an end of the first cylinder body 1 away from the first flow guide portion 3. Along the axial direction of the gas-liquid separator 100, a projection of the third part 41 completely falls into a projection of the second cylinder body 2, and a projection of the fourth part 42 completely falls into a projection of the first cylinder body 1. At least part of the outer side wall surface of the third part 41 is in sealing connection with part of the inner side wall surface of the second cylinder body 2. In other embodiments, the third part 41 may be similar in structure to the second part 32. The third part 41 has a stepped surface, and the second cylinder body 2 abuts against the stepped surface. Along the axial direction of the gas-liquid separator 100, the projection of the second cylinder body 2 completely falls into a projection of the third part 41. The fourth part 42 may be similar in structure to the second part 32. The fourth part 42 has a stepped surface, and the first cylinder body 1 abuts against the stepped surface. Along the axial direction of the gas-liquid separator 100, the projection of the first cylinder body 1 completely falls into a projection of the fourth part 42.

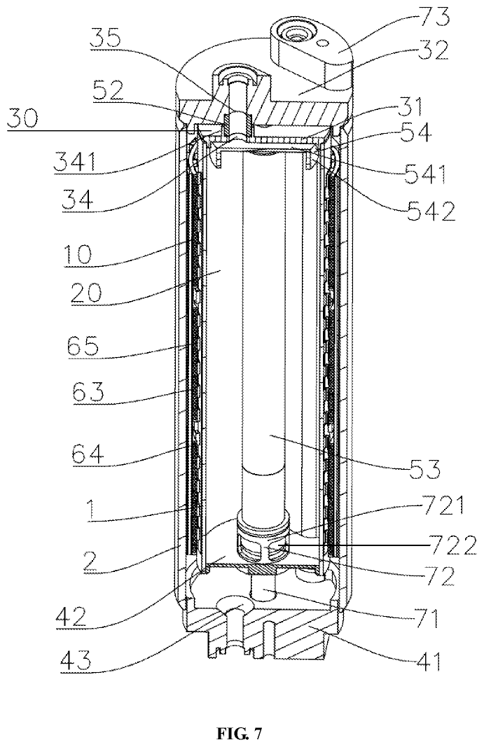

The third part 41 has a fourth through hole 43 that communicates with the outside of the gas-liquid separator 100 and the first cavity 10. The fourth through hole 43 is formed with openings on both opposite sides of the third part 41. In some embodiments, the opening formed on the side of the fourth through hole 43 adjacent to the first cavity 10 is larger than the opening formed on the side away from the first cavity 10. Referring to FIG. 7, it is specifically shown that the fourth through hole 43 is divided into two sections. A section away from the first cavity 10 is a substantially straight cylindrical first section. A section adjacent to the first cavity 10 is a substantially flared second section. A contour size of a cross section of one end of the second section is the same as a contour size of a cross section of the first section. A contour size of a cross section of the other end of the second section is larger than a contour size of a cross section of the first section.

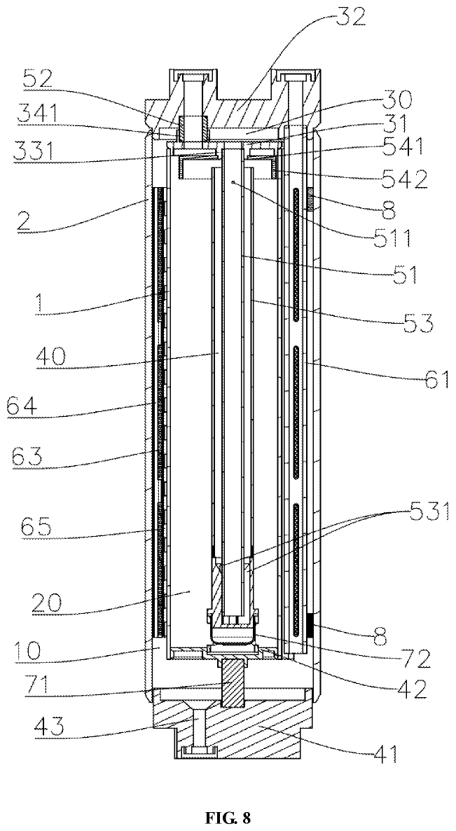

The gas-liquid separator 100 is provided with a first support member 71 abutting between the third part 41 and the fourth part 42. In this embodiment, as shown in FIG. 2, FIG. 7 and FIG. 8, the first support member 71 is a substantially straight cylinder body. The third part 41 and the fourth part 42 are respectively provided with grooves for accommodating the ends of the first support member 71, thereby increasing the stability of the first support member 71 supporting the third part 41 and the fourth part 42. In some other embodiments, the first support member 71 may be at least one protrusion formed by extending from the third part 41 or the fourth part 42. The protrusion is located between the third part 41 and the fourth part 42 for supporting the third part 41 and the fourth part 42.

In some other embodiments, the second flow guide portion 4 may only include the third part 41 which is covered to the second cylinder body 2. The first cylinder body 1 includes a cylinder body portion and a bottom cover integrally formed with the cylinder body portion.

The first support member 71 abuts between the third part 41 and the bottom cover. The matching relationship among the bottom cover, the first support member 71 and the third part 41 is similar to the matching relationship among the third part 41, the fourth part 42 and the first support member 71, and details are not repeated here.

The third part 41 is connected to the pipeline connection assembly. When the first connecting member 73 and the second connecting member are fixedly connected by the fastener, the first cavity 10 communicates with the outside of the gas-liquid separator 100, and the gas-liquid separator 100 is connected to a thermal management system.

In this embodiment, during installation, the end surface of one end of the first cylinder body 1 abuts against the first stepped surface 313, the inner wall surface of the first cylinder body 1 is welded to the second side wall surface 315, and the inner wall surface of the other end of the first cylinder body 1 is welded to the outer side wall surface of the fourth part 42, thereby realizing the sealing of the first cylinder body 1. The end surface of one end of the second cylinder body 2 abuts against the second stepped surface 323, the inner wall surface of the second cylinder body 2 is welded to the fourth side wall surface 325, and the inner side wall surface of the other end of the second cylinder body 2 is welded to the outer side wall surface of the third part 41, thereby realizing the sealing of the second cylinder body 2.

In this embodiment, referring to FIG. 2, FIG. 7, and FIG. 8, the gas-liquid distribution assembly 5 includes a flow guide pipe 51, a connecting pipe 52, a sleeve 53 and a first plate/umbrella cap 54. The sleeve 53 is sleeved on an outer side of the flow guide pipe 51. The first plate 54 has a through hole. One end of the flow guide pipe 51 passes through the through hole so that the first plate 54 is sleeved on an upper part of the flow guide pipe 51. The first plate 54 is located above the sleeve 53. Part of the side wall of the first extension portion 331 is accommodated in the through hole of the first plate 54, and the fixing of the first plate 54 is completed. After one end of the flow guide pipe 51 passes through the through hole of the first plate 54, the end surface of the flow guide pipe 51 abuts against a lower side surface of the first part 31. The inner cavity of the flow guide pipe 51 communicates with the first through hole 33.

The first plate 54 includes a main body portion 541 sleeved on the flow guide pipe 51 and an outer extension portion 542 extending downwardly along an outer edge of the main body portion 541. A gap is formed between an upper surface of the main body portion 541 and the first part 31, so that a first fluid can flow into the second cavity 20 from the connecting pipe 52. A gap is formed between an outer wall surface of the outer extension portion 542 and the inner wall surface of the first cylinder body 1, so that the first fluid continues to flow downwardly after entering the second cavity 20 from the connecting pipe 52. A gap is formed between a lower surface of the main body portion 541 and an upper end surface of the sleeve 53, a gap is formed between an inner wall surface of the outer extension portion 542 and an outer wall of the sleeve 53, and an end of the sleeve 53 adjacent to the first plate 54 is open, so that the second cavity 20 communicates with the inner cavity of the sleeve 53. A diameter of the main body portion 541 is smaller than an inner diameter of the first cylinder body 1 and larger than an outer diameter of the sleeve 53.

The inner wall surface of the sleeve 53 and the outer wall surface of the flow guide pipe 51 are spaced by a predetermined distance, so that a channel 40 for the first fluid to flow is formed between the inner wall surface of the sleeve 53 and the outer wall surface of the flow guide pipe 51. One end of the sleeve 53 away from the first plate 54 is sealed, so that the inner cavity of the sleeve 53 is isolated from the second cavity 20 at the end away from the first plate 54. A gap is left between the inner wall surface of the lower end of the flow guide pipe 51 and the lower end surface of the sleeve 53, so that the channel 40 communicates with the inner cavity of the flow guide pipe 51.

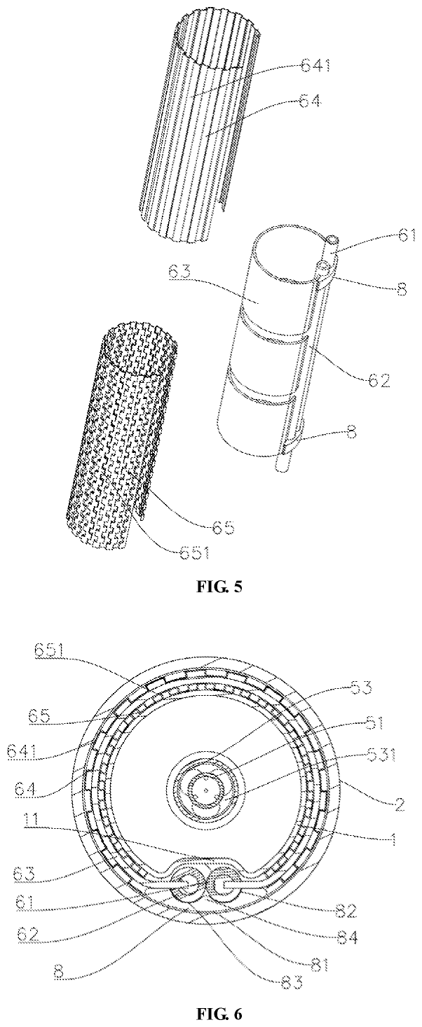

In this embodiment, the sleeve 53, the flow guide pipe 51 and the connecting pipe 52 are all hollow cylinders with substantially circular cross sections. One end of the flow guide pipe 51 is connected to the first part 31 and communicated with the third cavity 30, and the other end is open and communicated with the channel 40. One end of the connecting pipe 52 is connected to the first part 31 and communicated with the second cavity 20, and the other end is connected to the second part 32 and communicated with the outside of the gas-liquid separator 100. One end of the sleeve 53 adjacent to the fourth part 42 is self-sealing, and the other end is open and communicated with the second cavity 20. A limiting structure 531 is provided on the inner side wall of the sleeve 53 adjacent to one end of the fourth part 42. The end of the flow guide pipe 51 extends into the limiting structure 531, so as to fix the sleeve 53 and the flow guide pipe 51. This can be used to limit the displacement of the sleeve 53, but the design of the limit structure 531 does not affect the flow of the first fluid. Referring to FIG. 6 and FIG. 8, the limiting structure 531 is three protrusions evenly distributed along a circumference of the inner wall of the sleeve 53.

In some embodiments, the sleeve 53 can be fixed only by the limiting structure, or the sleeve 53 can also be connected with the first plate 54 to realize the fixation of the sleeve 53, or the sleeve 53 can also be connected to the fourth part 42 to realize the fixation of the sleeve 53.

In some embodiments, a side wall of the flow guide pipe 51 adjacent to one end of the first part 31 is provided with a balance hole 511 that communicates with the channel 40 and the inner cavity of the flow guide pipe 51 (refer to FIG. 8). The balance hole 511 is used to reduce the phenomenon that the liquid first fluid is sucked into the compressor 300 due to the pressure difference when the compressor 300 is stopped.

The gas-liquid separator 100 is also provided with a filter assembly 72. The filter assembly 72 is fixed to one end of the sleeve 53 adjacent to the fourth part 42. The filter assembly 72 includes a filter screen 721 and a bracket 722. The bracket 722 abuts between the sleeve 53 and the fourth part 42 for fixing the filter screen 721, and can also be used to limit the sleeve 53 to reduce the shaking of the gas-liquid distribution assembly 5. The fourth part 42 may also be provided with a boss or groove that is matched with the bracket 722. One end of the bracket 722 is sleeved on the outside of the boss or inserted into the groove. The sleeve 53 may be provided with an oil return hole (not shown) adjacent to the bottom end or the side wall of the fourth part 42. A diameter of the oil return hole is matched according to the capacity of the thermal management system, so that the ratio of the refrigerant oil and the first fluid returning to the compressor 300 can be better. The filter screen 721 can prevent impurities from entering the compressor 300 through the oil return hole.

In some other embodiments, the sleeve 53 may be sealed and fixed with the fourth part 42 at one end and open at the other end. One end of the sleeve 53 can also be sealed and fixed to the fourth part 42 and the other end of the sleeve 53 can be sealed and fixed to the first plate 54. However, the end of the sleeve 53 adjacent to the first plate 54 is provided with an opening, and the opening communicates the inner cavity of the sleeve 53 with the second cavity 20. The sleeve 53 can also be sealed by itself at one end but fixed or connected to the fourth part 42, and open at the other end or connected to the first plate 54. However, the inner cavity of the sleeve 53 adjacent to the end of the first plate 54 communicates with the second cavity 20. The sleeve 53 can also be fixed to the first plate 54 at one end, and the other end is sealed by itself and not in contact with the fourth part 42. The inner cavity of the sleeve 53 adjacent to the end of the first plate 54 communicates with the second cavity 20.

It should be understood that when the gas-liquid separator 100 is not provided with the fourth part 42 but the first cylinder body 1 has a bottom cover, the matching relationship between the sleeve 53 and the bottom cover is similar to the matching relationship between the sleeve 53 and the fourth part 42, and details are not repeated here.

In some other embodiments, the gas-liquid distribution assembly 5 includes a flow guide pipe 51 and a connecting pipe 52. The flow guide pipe 51 is U-shaped, and one end thereof is higher than the other end. The higher end is connected to the first part 31, and the lower end is an open end. The open end is spaced apart from the second end face 312 by a predetermined distance. The first cylinder body 1 is provided with a connecting pipe 52, one end of which is connected to the second part 32 and the other end communicates with the second cavity 20 through the second through hole 34. A lower end surface of the connecting pipe 52 is lower than the open end, so that after the gas-liquid mixed refrigerant enters the second cavity 20 through the connecting pipe 52, the liquid refrigerant sinks due to gravity, the gaseous refrigerant floats up and flows into the U-shaped flow guide pipe 51 from the open end, and then enters the first cavity 10 through the third cavity 30.

When the gas-liquid separator 100 is working, flow directions of the first fluid are as follows: the first fluid flows into the second cavity 20 from the third through hole 35 through the connecting pipe 52, and continues to flow downwardly from the gap between the outer extension portion 542 and the inner wall surface of the first cylinder body 1. After that, the first fluid flows through the gap between the inner wall surface of the outer extension portion 542 and the outer wall surface of the sleeve 53, the gap between the lower surface of the main body portion 541 and the upper end surface of the sleeve 53, enters the channel 40 from the upper end of the sleeve 53, and continues to flow downwardly in the channel 40. After that, the first fluid enters the flow guide pipe 51 from the lower end of the flow guide pipe 51 and continues to flow upwardly in the flow guide pipe 51. After that, the first fluid enters the third cavity 30 from the first through hole 33, enters the first cavity 10 from the gap between the first part 31 and the second part 32, and continues to flow downwardly. Finally, the first fluid flows out of the gas-liquid separator 100 through the fourth through hole 43 of the third part 41 to enter the compressor 300. At this moment, the first fluid has completed the entire process of gas-liquid separation and heat exchange. Wherein, in the process of flowing in the first cavity 10, the first fluid exchanges heat with the heat exchange assembly 6.

It should be noted that, the first fluid entering the second cavity 20 from the first flow guide portion 3 is usually a first fluid mixed with gas and liquid. After entering the second cavity 20, the liquid first fluid sinks due to gravity, so that the liquid first fluid is stored in the first cylinder body 1 while the gaseous first fluid floats. Under the suction action of the compressor 300, the upper end of the sleeve 53 enters the channel 40, so that the liquid first fluid remains at the bottom of the first cylinder body 1, and the gaseous first fluid flows through the third cavity 30 and the first cavity 10, and then flows out of the gas-liquid separator 100 from the second flow guide portion 4, thereby realizing the gas-liquid separation of the first fluid.

In this embodiment, the gas-liquid separator 100 includes a heat exchange assembly 6 at least partially located in the first cavity 10. The heat exchange assembly 6 includes a first collecting pipe 61, a second collecting pipe 62, a heat exchange tube 63, a first heat exchange member/first fin 64, and a second heat exchange member/second fin 65. The second part 32 of the first flow guide portion 3 includes a fifth through hole 36 that communicates with the outside of the gas-liquid separator 100 and the heat exchange assembly 6. The third part 41 of the second flow guide portion 4 includes a sixth through hole 44 that communicates with the outside of the gas-liquid separator 100 and the heat exchange assembly 6. In this embodiment, one end of the first collecting pipe 61 is connected to the second part 32. One end of the second collecting pipe 62 is connected to the third part 41. The first collecting pipe 61 and the second collecting pipe 62 are disposed in parallel. One end of the first collecting pipe 61 is sealed and the other end of the first collecting pipe 61 communicates with the fifth through hole 36. One end of the second collecting pipe 62 is sealed and the other end of the second collecting pipe 62 communicates with the sixth through hole 44. At least part of the side wall of the first cylinder body 1 is recessed in a direction away from the second cylinder body 2 so as to form a first recess 11. At least part of the first collecting pipe 61 and the second collecting pipe 62 are accommodated in the first recess 11. Along the axial direction of the gas-liquid separator 100, the first part 31 is provided with a first avoidance part 316 at the part corresponding to the first recess 11, so as to facilitate the connection and assembly of the first collecting pipe 61 and the second part 32. Along the axial direction of the gas-liquid separator 100, a second avoidance portion 421 is provided at the portion of the fourth part 42 corresponding to the first recess 11 to facilitate the connection and assembly of the second collecting pipe 62 and the third part 41. Alternatively, the first cylinder body 1 may not be provided with the first recess 11 and the second recess 12.

A width of the heat exchange tube 63 is larger than a thickness thereof, and thus the heat exchange tube 63 has a flat shape. That is, a cross-sectional shape of the heat exchange tube 63 is flat. The number of heat exchange tubes 63 includes at least one. Each heat exchange tube 63 includes a plurality of flow channels extending along the heat exchange tube 63. The plurality of flow channels are spaced apart from each other.

In this embodiment, the number of heat exchange tubes 63 is three. The three heat exchange tubes 63 are disposed in parallel in the axial direction parallel to the gas-liquid separator 100. Each wide heat exchange tube 63 is disposed around the first cylinder body 1 to form an approximately cylindrical shape. One end of each heat exchange tube 63 is connected to the first collecting pipe 61 and the other end is connected to the second collecting pipe 62. Each flow channel of the heat exchange tube 63 communicates with the inner cavity of the first collecting pipe 61 and the inner cavity of the second collecting pipe 62.

The first heat exchange member 64 and the second heat exchange member 65 are located on opposite sides of the heat exchange tube 63, respectively. The first heat exchange member 64 and the second heat exchange member 65 are fixedly connected to opposite sides of the heat exchange tube 63 in the thickness direction, respectively. One side surface of the first heat exchange member 64 is adjacent to or attached to the inner wall surface of the second cylinder body 2, and the other side surface is connected to a side wall surface of the heat exchange tube 63. One side surface of the second heat exchange member 65 is adjacent to or attached to the outer wall surface of the first cylinder body 1, and the other side surface is connected to the other side wall surface of the heat exchange tube 63. The first heat exchange member 64 and the second heat exchange member 65 are disposed in the first cavity 10 to enhance heat exchange between a second fluid in the heat exchange tube 63 and the first fluid in the first cavity 10.

It should be understood that the connection means that the first heat exchange member 64, the second heat exchange member 65 and the heat exchange tube 63 may be integrally formed, or may be formed separately and connected together by processing. The heat exchange tube 63, the first heat exchange member 64 and the second heat exchange member 65 are all disposed around at least part of the first cylinder body 1.

The first heat exchange member 64 includes a first flow guide structure 641. The first flow guide structure 641 protrudes beyond a surface of the first heat exchange member 64. The first flow guide structure 641 may be provided only on one side of the first heat exchange member 64, or may be provided on both sides of the first heat exchange member 64. The first flow guide structure 641 has a first fluid flow channel inside; and/or, a first fluid flow channel is formed between two adjacent first flow guide structures 641. The second heat exchange member 65 includes a second flow guide structure 651. The second flow guide structure 651 protrudes beyond the surface of the second heat exchange member 65. The second flow guide structure 651 may be provided only on one side of the second heat exchange member 65, or may be provided on both sides of the second heat exchange member 65. The second flow guide structure 651 has a flow channel for the first fluid to flow inside; and/or, a flow channel for the first fluid to flow is formed between two adjacent second flow guide structures 651.

In the present application, the structure of the first heat exchange member 64 and the structure of the second heat exchange member 65 are different. The structure of the first heat exchange member 64 includes one or a combination of one or more of the shape of the first flow guide structure 641, the distribution density of the first flow guide structure 641 and the thickness of the first heat exchange member 64. The shape of the first flow guide structure 641 can be one or a combination of one or more of a strip structure, a corrugated structure, a zigzag structure, a staggered tooth structure, a louver structure, a needle structure, a perforated structure, any structure with protrusions, and any structure with grooves on the surface (refer to FIG. 11), as long as the purpose of guiding the flow of the first fluid and increasing the effect of heat exchange between the first fluid and the heat exchange assembly 6 can be achieved.

The structure of the second heat exchange member 65 includes one or a combination of one or more of the shape of the second flow guide structure 651, the distribution density of the second flow guide structure 651, and the thickness of the second heat exchange member 65. The shape of the second flow guide structure 651 can be one or a combination of one or more of a strip structure, a corrugated structure, a zigzag structure, a staggered tooth structure, a louver structure, a needle-shaped structure, a perforated structure, any structure with protrusions, and any structure with grooves on the surface (refer to FIG. 11), as long as the purpose of guiding the flow of the first fluid and increasing the effect of heat exchange between the first fluid and the heat exchange assembly 6 can be achieved.

In this embodiment, as shown in FIG. 5, the first flow guide structure 641 of the first heat exchange member 64 is a plurality of hollow strip structures disposed in parallel. Each strip structure extends in a direction parallel to the axis of the gas-liquid separator 100. A flow channel is formed inside the strip structure and between two adjacent strip structures. The strip structure guides the first fluid to flow in a substantially straight line from top to bottom. The second flow guide structure 651 of the second heat exchange member 65 is a staggered tooth structure. A flow channel is formed inside the staggered tooth structure and between two adjacent staggered tooth structures. The staggered tooth structure guides the fluid to flow from top to bottom in a roughly S-shape. In other embodiments, both the first heat exchange member 64 and the second heat exchange member 65 may have other shapes.

In order to ensure that there is a sufficient space in the first cylinder body 1 for storing the liquid first fluid, but the size of the first cavity 10 is relatively limited, in some designs of gas-liquid separators, the heat exchange requirements on both sides of the heat exchange tube 63 are different. If the first heat exchange member 64 and the second heat exchange member 65 use the same structure, that is, the heat exchange capacities on both sides of the heat exchange tube 63 are the same, the heat exchange capacity of the heat exchange assembly 6 may be wasted. Different structures may be used for the first heat exchange member 64 and the second heat exchange member 65 when designing the heat exchange assembly 6. For example, when a side of the first heat exchange member 64 needs more heat exchange capacity, while a side of the second heat exchange member 65 needs to weaken the heat exchange capacity, by setting the structure of the first heat exchange member 64 and the second heat exchange member 65, the flow resistance of the first heat exchange member 64 can be designed to be relatively small, and the flow resistance of the second heat exchange member 65 can be designed to be relatively large. Thereby, the distribution of the first fluid flowing into the first cavity 10 is improved. Most of the first fluid passes through the first heat exchange member 64 for heat exchange, so as to achieve the purpose of improving the heat exchange capacity of the first heat exchange member 64 and weakening the heat exchange capacity of the second heat exchange member 65.

In this embodiment, by setting the shape of the first flow guide structure 641 of the first heat exchange member 64 and the shape of the second flow guide structure 651 of the second heat exchange member 65 to be different, the flow resistance of the first heat exchange member 64 is made smaller than the flow resistance of the second heat exchange member 65. The first fluid flowing into the first cavity 10 from the third cavity 30 preferentially flows through the flow channel of the first heat exchange member 64, thereby reducing the first fluid flowing to the flow channel of the second heat exchange member 65. This can weaken the heat exchange between the first fluid in the second cavity 20 and the first fluid in the first cavity 10, and prevent the liquid first fluid stored in the first cavity 10 from being heated into a gaseous state and entering the circulation of the thermal management system.

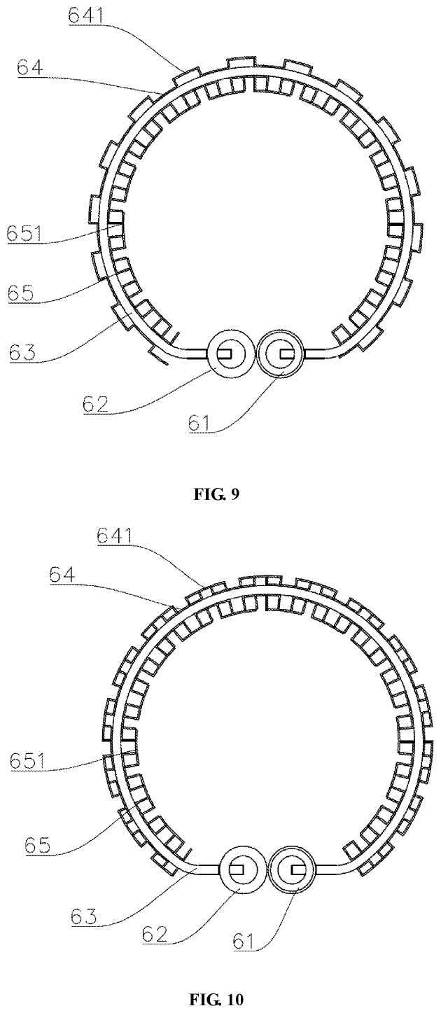

In other embodiments, referring to FIG. 10, the shape of the first flow guide structure 641 of the first heat exchange member 64 and the shape of the second flow guide structure 651 of the second heat exchange member 65 may be the same, but the first heat exchange member 64 and the second heat exchange member 65 have different thicknesses. Since the space of the first cavity 10 is limited, the distribution of the space on both sides of the heat exchange tube 63 is adjusted, and the space of the first cavity 10 is reasonably utilized, so that the heat exchange capacity of the heat exchange assembly 6 can be reasonably utilized. Referring to FIG. 9, the shape of the first flow guide structure 641 of the first heat exchange member 64 is different from the shape of the second flow guide structure 651 of the second heat exchange member 65. The thicknesses of the first heat exchange member 64 and the second heat exchange member 65 are also different. The densities of the first flow guide structure 641 and the second flow guide structure 651 are also different. By adjusting multiple parameters at the same time, adjusting the distribution of the space on both sides of the heat exchange tube 63 and adjusting the flow resistance of the first fluid on both sides of the heat exchange tube 63, the space of the first cavity 10 is rationally utilized, so that the heat exchange capacity of the heat exchange assembly 6 is utilized rationally.

Referring to FIG. 2, FIG. 7 and FIG. 8, in the present embodiment, a flow guide member 8 is provided between the first collecting pipe 61 and the second cylinder body 2, and the second collecting pipe 62 and the second cylinder body 2 in order to prevent the first fluid from flowing out of the first cavity 10 directly through the gaps between the first collecting pipe 61 and the second cylinder body 2, and the gaps between the second collecting pipe 62 and the second cylinder body 2. The flow guide member 8 may be connected to the first heat exchange member 64, or may not be connected to the first heat exchange member 64. The present application does not limit this, which can be set according to a specific application environment.

The flow guide member 8 at least includes two parts located at an upper end of the first collecting pipe 61 and a lower end of the first collecting pipe 61 to prevent that part of the first fluid flowing out of the third cavity 30 directly flows downwardly through the gaps between the first collecting pipe 61 and the second cylinder body 2, and the gaps between the second collecting pipe 62 and the second cylinder body 2 to flow out of the first cavity 10. That is, the first fluid can flow through the first heat exchange member 64 and the second heat exchange member 65 on the inner and outer sides of the heat exchange tube 63 as much as possible, thereby helping to improve the heat exchange efficiency of the gas-liquid separator 100.

Referring to FIG. 2, FIG. 5, FIG. 6 and FIG. 8, the flow guide member 8 includes a first mating surface 81 mated with the second cylinder body 2, a second mating surface 82 mated with the first collecting pipe 61, and a third mating surface 83 mated with the second collecting pipe 62. Alternatively, the first mating surface 81 and the second cylinder body 2 may be attached to each other in a matching manner. That is, the first mating surface 81 is a curved surface, which can effectively prevent the first fluid from flowing out of the first cavity 10 from the gap between the flow guide member 8 and the inner wall surface of the second cylinder body 2. A protruding rib 84 is provided between the second mating surface 82 and the third mating surface 83. One side of the wall surface of the protruding rib 84 is extended and connected to the second mating surface 82, and the other side is extended and connected to the third mating surface 83. The protruding rib 84 is provided in the gap between the first collecting pipe 61 and the second collecting pipe 62. One side of the wall surface of the protruding rib 84 is provided in contact with the first collecting pipe 61, and the other side is provided in contact with the second collecting pipe 62. The second mating surface 82 is disposed in contact with the first collecting pipe 61. The third mating surface 83 is disposed in contact with the second collecting pipe 62. This can effectively prevent the first fluid from flowing out of the first cavity 10 from the gaps between the first collecting pipe 61, the second collecting pipe 62 and the flow guide member 8.

When the gas-liquid separator 100 is working, flow directions of the second fluid in the cooling mode are as follows: the second fluid flows into the heat exchange tube 63 from the sixth through hole 44 through the second collecting pipe 62, flows along the heat exchange tube 63 to the first collecting pipe 61, and finally the second fluid flows out of the gas-liquid separator 100 from the fifth through hole 36. Flow directions of the second fluid in the heating mode are as follows: the second fluid flows into the heat exchange tube 63 from the fifth through hole 36 through the first collecting pipe 61, flows along the heat exchange tube 63 to the second collecting pipe 62, and finally the second fluid flows out of the gas-liquid separator 100 from the sixth through hole 44. At this moment, the second fluid completes the entire process of heat exchange. Wherein, in the first cavity 10, the second fluid flowing in the inner cavity of the heat exchange tube 63 and the first fluid flowing in the first cavity 10 perform heat exchange.

When the gas-liquid separator 100 is working, due to the action of gravity, the liquid first fluid will be stored at the end of the first cylinder body 1 adjacent to the second flow guide portion 4. The gaseous first fluid flows into the first cavity 10 through the gas-liquid distribution assembly 5 to exchange heat with the heat exchange assembly 6. After that, the first fluid flows out of the gas-liquid separator 100. Since the refrigerant charge required by the thermal management system is different under different working conditions, the gas-liquid separator 100 in the related art will store the liquid refrigerant, and then, by adjusting whether to export the liquid refrigerant and adjusting the amount of the liquid refrigerant to be exported, the refrigerant charging amount of the thermal management system is adjusted.

If the stored liquid first fluid exchanges heat with the heat exchange assembly 6 or the first fluid in the first cavity 10, the first fluid may be heated into a gaseous state to enter the heat exchange cycle of the thermal management system, which will affect the heat transfer performance of the thermal management system. Therefore, by reducing the heat exchange performance of the second heat exchange member 65 on the side adjacent to the first cylinder body 1, the liquid first fluid in the first cylinder body 1 and the heat exchange assembly 6 or the first fluid in the first cavity 10 are reduced, thereby ensuring the normal operation of the thermal management system, and ensuring the heat exchange performance of the thermal management system.

According to another specific embodiment of the gas-liquid separator 100 of the present application, the difference between this embodiment and the above-mentioned embodiment is that the structure of the heat exchange assembly 6 is different, and the specific performance is as follows. In this embodiment, the gas-liquid separator 100 includes a first portion adjacent to the first flow guide portion 3 and a second portion adjacent to the second flow guide portion 4. The structure of the second heat exchange member 65 corresponding to the first portion and the structure of the second heat exchange member 65 corresponding to the second portion are different. Since the liquid first fluid is mainly stored at one end of the first cylinder body 1 adjacent to the second flow guide portion 4 (i.e., an area corresponding to the second portion), the second heat exchange member 65 adjacent to the first cylinder body 1 can be further disposed in different regions, for example, only the heat exchange capacity of the second heat exchange member 65 corresponding to the second portion can be weakened, that is, the structure of the second heat exchange member 65 corresponding to the second portion is adjusted. Alternatively, the heat exchange capacity of the second heat exchange member 65 corresponding to the first portion may be consistent with that of the first heat exchange member 64.

In some specific embodiments, the density of the second flow guide structure 651 of the second heat exchange member 65 corresponding to the second portion can be reduced, so that the heat exchange capacity of the second heat exchange member 65 corresponding to the second portion is reduced. The heat exchange between the liquid first fluid in the first cylinder body 1 and the first fluid in the first cavity 10 or the heat exchange assembly 6 is minimized.

In this embodiment, only the heat exchange capacity of the second heat exchange member 65 adjacent to the second flow guide portion 4 can be weakened, so as to reduce the heat exchange between the liquid first fluid in the first cylinder body 1 and the heat exchange assembly 6 or the first fluid in the first cavity 10. On the basis of weakening the entire second heat exchange member 65, the heat exchange capacity of the second heat exchange member 65 corresponding to the second portion may be further weakened.

The parts of this embodiment that are the same as the above-mentioned embodiments will not be repeated here.

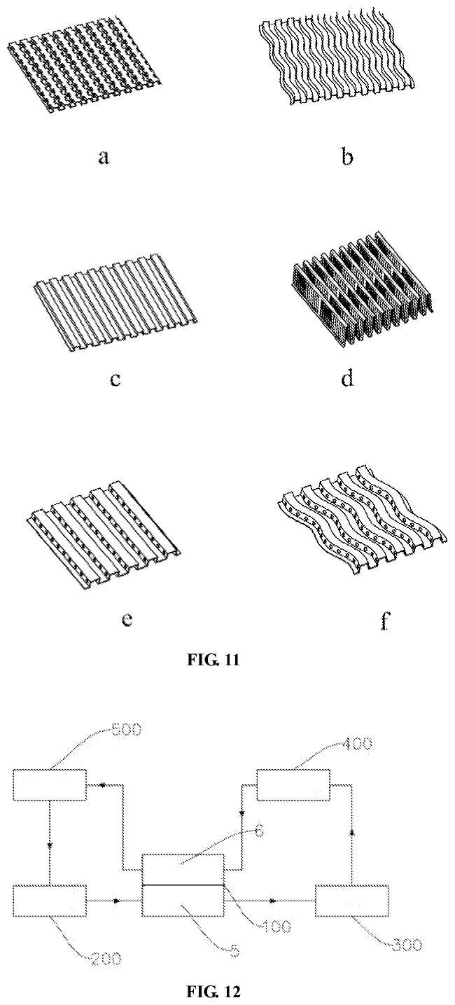

FIG. 12 is a schematic connection view of the thermal management system according to an exemplary embodiment of the present application. Directions indicated by the arrows are the refrigerant flow directions. The thermal management system is in a cooling mode. Referring to FIG. 12, the thermal management system includes a gas-liquid separator 100, an evaporator 200, a compressor 300, a condenser 400 and a throttling device 500. The evaporator 200 is connected to the gas-liquid distribution assembly 5 through the first flow guide portion 3 of the gas-liquid separator 100. An outlet of the evaporator 200 communicates with the third through hole 35. The compressor 300 is connected to the gas-liquid distribution assembly 5 through the second flow guide portion 4 of the gas-liquid separator 100. An inlet of the compressor 300 communicates with the fourth through hole 43. The condenser 400 is connected to the heat exchange assembly 6 through the second flow guide portion 4 of the gas-liquid separator 100. An outlet of the condenser 400 communicates with the sixth through hole 44. The throttling device 500 is connected to the heat exchange assembly 6 through the first flow guide portion 3 of the gas-liquid separator 100. An inlet of the throttling device 500 communicates with the fifth through hole 36. In the cooling mode, the high-temperature gaseous refrigerant flowing out from the compressor 300 flows through the heat exchange assembly 6 in the gas-liquid separator 100 after being heat-exchanged with the condenser 400. Then, after the refrigerant is throttled by the throttling device 500, it enters the evaporator 200 for heat exchange. The gas-liquid two-phase refrigerant flowing out of the evaporator 200 enters the gas-liquid separator 100, and after gas-liquid separation by the gas-liquid separator 100, the refrigerant flows into the compressor 300 to complete a heat exchange cycle. In the gas-liquid separator 100, the liquid refrigerant is stored in the first cylinder body 1 through the action of the gas-liquid distribution assembly 5. The gaseous refrigerant exchanges heat with the heat exchange assembly 6. After the heat exchange, the temperature of the gaseous refrigerant increases, and the temperature of the refrigerant flowing in the heat exchange assembly 6 decreases, so that the temperature of the refrigerant entering the compressor 300 can be raised. In addition, the temperature of the refrigerant flowing into the throttling device 500 is lowered, so that the cooling effect of the evaporator 200 is improved.

In a heating mode, the high-temperature gaseous refrigerant flowing out of the compressor 300 enters the condenser 400 for heat exchange, and then flows through the heat exchange assembly 6 in the gas-liquid separator 100 after being throttled by the throttling device 500. Then, the refrigerant enters the evaporator 200 for heat exchange. The gas-liquid two-phase refrigerant flowing out of the evaporator 200 enters the gas-liquid separator 100, and after gas-liquid separation by the gas-liquid separator 100, the refrigerant flows into the compressor 300 to complete a heat exchange cycle.

Since the heat exchange assembly 6 and the gas-liquid distribution assembly 5 are simultaneously disposed in the gas-liquid separator 100, the heat exchange assembly 6 and the gaseous refrigerant after heat exchange will exchange heat with the liquid refrigerant stored in the first cylinder body 1. The liquid refrigerant that should be stored in the first cylinder body 1 may be vaporized after heat exchange, then enters the compressor, and then enters the heat exchange cycle, which may affect the performance of the thermal management system. In the present application, the space size of the first cavity 10 is fixed, and the heat exchange capacity of the second heat exchange member 65 adjacent to the first cylinder body 1 is weakened by disposing the first heat exchange member 64 and the second heat exchange member 65 with different structures. This can reduce the heat exchange between the liquid refrigerant in the first cylinder body 1 and the gaseous refrigerant in the heat exchange assembly 6 and the first cavity 10, thereby ensuring the heat exchange performance of the thermal management system.

It should be understood in the present application that the above-mentioned first fluid and second fluid are both refrigerants. The first fluid is the refrigerant flowing out of the evaporator 200. The second fluid is the refrigerant flowing out of the condenser 400 or the throttling device 500.

“Substantially” and “approximately” mentioned in the present application means that the similarity is more than 50%. For example, when the first cylinder body 1 is approximately cylindrical, it means that the first cylinder body 1 has a hollow cylindrical shape, a side wall of the first cylinder body 1 may be provided with a recess portion or a convex structure, and a contour of a cross-section of the first cylinder body 1 is not circular, but 50% of the contour consists of arcs.

The above descriptions are only preferred embodiments of the present application, and do not limit the present application in any form. Although the present application has been disclosed as above with preferred embodiments, it is not intended to limit the present application. Any person skilled in the art, within the scope of the technical solution of the present application, can make some changes or modifications by using the technical contents disclosed above to be equivalent embodiments of equivalent changes. However, any simple modifications, equivalent changes and modifications made to the above embodiments according to the technical essence of the present application without departing from the content of the technical solutions of the present application still fall within the scope of the technical solutions of the present application.

1. A gas-liquid separator, comprising: a first cylinder body, a second cylinder body, a first flow guide portion, a second flow guide portion, a gas-liquid distribution assembly and a heat exchange assembly;
the first cylinder body being located inside the second cylinder body, the gas-liquid separator having a first cavity and a second cavity, the first cavity at least comprising a space inside the second cylinder body and outside the first cylinder body, the second cavity at least comprising a space inside the first cylinder body, the heat exchange assembly being at least partially located in the first cavity;
the gas-liquid distribution assembly comprising a flow guide pipe, the first flow guide portion being fixed with the second cylinder body, the first flow guide portion having a third cavity, the flow guide pipe being fixed with the first flow guide portion, one end of the flow guide pipe communicating with the third cavity, another end of the flow guide pipe communicating with the second cavity, the third cavity communicating with the first cavity;
the second flow guide portion being fixed with the second cylinder body, the first flow guide portion and the second flow guide portion being located on different sides of the second cylinder body;
the heat exchange assembly comprising a heat exchange tube, a first heat exchange member and a second heat exchange member, the heat exchange tube at least partially surrounding the first cylinder body, one side of the first heat exchange member being disposed adjacent to or attached to the second cylinder body, another side of the first heat exchange member being fixed with the heat exchange tube, one side of the second heat exchange member being disposed adjacent to or attached to the first cylinder body, another side of the second heat exchange member being fixed with the heat exchange tube, a structure of the first heat exchange member being different from a structure of the second heat exchange member.

2. The gas-liquid separator according to claim 1, wherein the first heat exchange member comprises a first flow guide structure, the structure of the first heat exchange member comprises one or a combination of a shape of the first flow guide structure, a distribution density of the first flow guide structure, and a thickness of the first heat exchange member;
the second heat exchange member comprises a second flow guide structure, the structure of the second heat exchange member comprises one or a combination of a shape of the second flow guide structure, a distribution density of the second flow guide structure, and a thickness of the second heat exchange member.

3. The gas-liquid separator according to claim 2, wherein the shape of the first flow guide structure is one or a combination of a strip structure, a corrugated structure, a zigzag structure, a staggered tooth structure, a louver structure, a needle structure and a perforated structure;
the shape of the second flow guide structure is one or a combination of a strip structure, a corrugated structure, a zigzag structure, a staggered tooth structure, a louver structure, a needle structure and a perforated structure.

4. The gas-liquid separator according to claim 2, wherein the shapes of the first flow guide structure and the second flow guide structure are the same, while distribution densities and/or thicknesses of the first flow guide structure and the second flow guide structure are different.

5. The gas-liquid separator according to claim 2, wherein the shape of the first flow guide structure and the shape of the second flow guide structure are different.

6. The gas-liquid separator according to claim 1, wherein when the gas-liquid separator is working, a refrigerant flows in the first cavity, a flow resistance of the refrigerant corresponding to the first heat exchange member is smaller than a flow resistance of the refrigerant corresponding to the second heat exchange member.

7. The gas-liquid separator according to claim 6, wherein a thickness direction of the first heat exchange member and a thickness direction of the second heat exchange member are both perpendicular to an axis direction of the gas-liquid separator, the thickness of the first heat exchange member is greater than the thickness of the second heat exchange member.

8. The gas-liquid separator according to claim 6, wherein the first cylinder body of the gas-liquid separator comprises a first portion adjacent to the first flow guide portion and a second portion adjacent to the second flow guide portion, the structure of the second heat exchange member corresponding to the second portion is different from the structure of the second heat exchange member corresponding to the first portion, the flow resistance of the refrigerant of the second portion corresponding to the second heat exchange member is smaller than the flow resistance of the refrigerant of the first portion corresponding to the second heat exchange member;
the distribution density of the second flow guide structure corresponding to the second portion is smaller than the distribution density of the second flow guide structure corresponding to the first portion.

9. (canceled)

10. A gas-liquid separator, comprising: a first cylinder body, a second cylinder body, a first flow guide portion, a second flow guide portion, a gas-liquid distribution assembly and a heat exchange assembly;
the second cylinder body being sleeved on an outside of the first cylinder body, the gas-liquid separator having a first cavity and a second cavity, the first cavity at least comprising a portion located between the second cylinder body and the first cylinder body, the second cavity at least comprising a portion located in the first cylinder body;
the first flow guide portion and the second flow guide portion being located at opposite ends of the second cylinder body, respectively; the first flow guide portion and the second flow guide portion being fixed to the second cylinder body, respectively; the first air guide having a third cavity communicating with the first cavity;
the gas-liquid distribution assembly comprising a flow guide pipe communicating with the second cavity and the third cavity;
the heat exchange assembly comprising a heat exchange tube, a first heat exchange member and a second heat exchange member, the heat exchange tube being at least partially located in the first cavity, the first heat exchange member and the second heat exchange member being located on opposite sides of the heat exchange tube, the first heat exchange member and the second heat exchange member being fixed to the heat exchange tube, respectively; a structure of the first heat exchange member being different from a structure of the second heat exchange member.

11. The gas-liquid separator according to claim 10, wherein the first heat exchange member is located between the second cylinder body and the heat exchange tube; one side of the first heat exchange member is disposed adjacent to or attached to the second cylinder body, and another side of the first heat exchange member is fixed to the heat exchange tube; the second heat exchange member is located between the first cylinder body and the heat exchange tube; one side of the second heat exchange member is disposed adjacent to or attached to the first cylinder body, and another side of the second heat exchange member is fixed to the heat exchange tube.

12. The gas-liquid separator according to claim 10, wherein the first heat exchange member comprises a first flow guide structure, the structure of the first heat exchange member comprises one or a combination of a shape of the first flow guide structure, a distribution density of the first flow guide structure, and a thickness of the first heat exchange member;
the second heat exchange member comprises a second flow guide structure, the structure of the second heat exchange member comprises one or a combination of a shape of the second flow guide structure, a distribution density of the second flow guide structure, and a thickness of the second heat exchange member.

13. The gas-liquid separator according to claim 12, wherein the shape of the first flow guide structure is one or a combination of a strip structure, a corrugated structure, a zigzag structure, a staggered tooth structure, a louver structure, a needle structure and a perforated structure;
the shape of the second flow guide structure is one or a combination of a strip structure, a corrugated structure, a zigzag structure, a staggered tooth structure, a louver structure, a needle structure and a perforated structure;
the shapes of the first flow guide structure and the second flow guide structure are the same, while distribution densities and/or thicknesses of the first flow guide structure and the second flow guide structure are different; or
the shape of the first flow guide structure and the shape of the second flow guide structure are different.

14-15. (canceled)

16. The gas-liquid separator according to claim 10, wherein a flow resistance of the first heat exchange member is smaller than a flow resistance of the second heat exchange member.

17. The gas-liquid separator according to claim 16, wherein a thickness direction of the first heat exchange member and a thickness direction of the second heat exchange member are both perpendicular to an axis direction of the gas-liquid separator, the thickness of the first heat exchange member is greater than the thickness of the second heat exchange member.

18. The gas-liquid separator according to claim 16, wherein the first cylinder body of the gas-liquid separator comprises a first portion adjacent to the first flow guide portion and a second portion adjacent to the second flow guide portion, the structure of the second heat exchange member corresponding to the second portion is different from the structure of the second heat exchange member corresponding to the first portion, the flow resistance of the second heat exchange member corresponding to the second portion is smaller than the flow resistance of the second heat exchange member corresponding to the first portion;
the distribution density of the second flow guide structure corresponding to the second portion is smaller than the distribution density of the second flow guide structure corresponding to the first portion.

19. (canceled)

20. A gas-liquid separator, comprising:
an inner cylinder body, the inner cylinder body having an inner cavity;
an outer cylinder body, the inner cylinder body being at least partially disposed inside the outer cylinder body, an outer wall of the inner cylinder body and an inner wall of the outer cylinder body forming an interlayer cavity;
end caps, the end caps being covered on ends of the outer cylinder body in a longitudinal direction, the end caps having a first fluid channel and a second fluid channel;
a heat exchange assembly, the heat exchange assembly being at least partially disposed in the interlayer cavity, the heat exchange assembly comprising a heat exchange tube, a first fin and a second fin, the heat exchange tube defining a plurality of flow channels to communicate with the first fluid channel, a refrigerant circulating in the heat exchange tube and a refrigerant circulating in the interlayer cavity being suitable to exchange heat, the first fin being located between the heat exchange tube and the inner wall of the outer cylinder body, the second fin being located between the outer wall of the inner cylinder body and the heat exchange tube;
a flow guide pipe, the flow guide pipe being configured to guide a gaseous refrigerant in the inner cylinder body to the interlayer cavity, one end of the flow guide pipe communicating with the inner cavity, another end of the flow guide pipe communicating with the interlayer cavity, the interlayer cavity communicating with the second fluid channel;
wherein a structure of the first fin is different from a structure of the second fin.

21. The gas-liquid separator according to claim 20, wherein at least one of the shape, size, thickness, and density of the first fin is different from the second fin; when the gas-liquid separator is working, a refrigerant flows in the flow channels of the heat exchange tube, the inner cavity of the inner cylinder body and the interlayer cavity, and the refrigerant circulating in the heat exchange tube exchanges heat with the refrigerant circulating in the interlayer cavity.

22. The gas-liquid separator according to claim 20, wherein the end caps comprise a first end cap and a second end cap, the first end cap and the second end cap are connected to opposite sides of the outer cylinder body in the longitudinal direction, respectively; the first end cap has a third through hole and a fifth through hole, the second end cap has a fourth through hole and a sixth through hole, the fifth through hole and the sixth through hole form the first fluid channel, the third through hole and the fourth through hole form the second fluid channel;
the heat exchange assembly comprises a first collecting pipe and a second collecting pipe, the flow channels of the heat exchange tube communicates with a cavity of the first collecting pipe and a cavity of the second collecting pipe, the cavity of the first collecting pipe communicates with the fifth through hole, the second collecting pipe communicates with the sixth through hole;
the gas-liquid separator further comprises a cover, the cover is covered on one side of the inner cylinder body in the longitudinal direction, the cover is closer to the first end cap than the second end cap, an interval cavity is formed between the cover and the first end cap, the interval cavity communicates with the interlayer cavity;
the gas-liquid separator further comprises a connecting pipe, one end of the connecting pipe is connected to the first end cap, another end of the connecting pipe is connected to the cover, a cavity of the connecting pipe communicates with the third through hole and the inner cavity.

23. The gas-liquid separator according to claim 22, wherein the first fin comprises a first portion and a second portion which are distributed along the longitudinal direction of the gas-liquid separator, the first portion is disposed closer to the first end cap than the second portion, the second portion is disposed closer to the second end cap than the first portion, the flow resistance of the refrigerant corresponding to the first portion is greater than the flow resistance of the refrigerant corresponding to the second portion;
and/or, the second fin comprises a first portion and a second portion which are distributed in the longitudinal direction of the gas-liquid separator, the first portion is disposed closer to the first end cap than the second portion, the second portion is disposed closer to the second end cap than the first portion, the flow resistance of the refrigerant corresponding to the first portion is greater than the flow resistance of the refrigerant corresponding to the second portion.

24. The gas-liquid separator according to claim 22, further comprising an umbrella cap and a sleeve, the umbrella cap being partially located in the inner cavity, the umbrella cap being fixedly connected with the cover, a side of the sleeve adjacent to the cover having an opening, the flow guide pipe being partially located in the sleeve, the flow guide pipe having a portion located partially inside the sleeve, partially outside the sleeve and inside the umbrella cap.

25. (canceled)
